(19) United States
(12) Patent Application Publication
(10) Pub. No.: US 2012/0307981 A1
(43) Pub. Date: Dec. 6, 2012

(54) Switched Multi-Lead Test Adapter

(76) Inventor: Kevin B. Larkin, Pebble Beach, CA (US)

(21) Appl. No.: 13/150,443

(22) Filed: Jun. 1, 2011

(51) Int. Cl. H04M 3/22

(52) U.S. Cl. 379/27.01

(57) ABSTRACT

A switched multi-lead test adapter is described. The multi-lead adapter has a main lead and a plurality of test leads. Each lead is connected to a switch that selects one of the test leads for connection to the main lead, or for connection to another test lead. The switch allows only one conductive path between the leads, so that the remaining, unselected leads to not cause interference on an active telecommunication wire, such as a DSL line. The test leads include multiple terminating connectors for connecting to various terminal blocks and cabling systems.

### TECHNICAL FIELD

The disclosed embodiments relate generally to multi-lead adapter cables for connecting telecommunication wires.

### BACKGROUND

Across the world, countless miles of telecommunication wires are used to interconnect hundreds of millions of communication devices to one another. As advanced as our technology becomes, however, these telecommunication wires still require skilled technicians to install, troubleshoot, and repair the physical wires and communications equipment. Due to the numerous different types of terminating connectors used at the termination points of telecommunication wires, field technicians must carry multiple different types of cables so that they are able to connect their testing devices to any type of terminal block or connector that they may encounter in the field. Furthermore, testing devices do not include connectors or cables for each and every type of terminating connector that may be used. Thus, a lost or forgotten test cable can result in prolonged repair times, as a technician may have to make multiple trips to a repair or installation site in order to fetch the proper cable. This can result in lost time and money for telecommunication companies, as well as the entities that rely on the wires in need of repairs.

Thus, a multi-lead test adapter that facilitates connection between telecommunication testing devices and various types of terminating connectors would be desirable. One solution is to splice several test leads, each with different terminating connectors, onto a main lead that is compatible with many testing devices. However, these solutions are imperfect.

In particular, because of the sensitivity of modern communication equipment, such as DSL modems, unused test leads of such an adapter can cause “bridge taps” on the telecommunication wire which may cause detrimental impedance mismatches on the circuit. Specifically, an unconnected test lead (a bridge tap) can reflect the signal on a telecommunication wire back onto the wire, causing attenuation distortion and other impairments of the signal. This distortion can disrupt communications on the wire, and can even prevent attached communications equipment, such as DSL modems, from being able to interpret received signals.

Thus, it is advantageous to provide an adapter that addresses the above described problems.

### SUMMARY

The above deficiencies and other problems associated with telecommunication cabling are reduced or eliminated by the disclosed embodiments.

A multi-lead test adapter is described. The adapter includes a main lead and a plurality of test leads. The main lead and the test leads are connected to a switch. The main lead includes a terminating connector for connection to a telecommunication testing device or a telecommunication wire. The test leads each include a respective terminating connector for connecting to a respective type of telecommunication wire termination point.

The multi-lead test adapter is configured to conductively couple a telecommunication testing device to a telecommunication wire through one of the test leads. The test lead is coupled to the telecommunication wire at a terminating point, such as a terminal block. Only one test lead is conductively coupled to the main lead at a time, so that the remaining unconnected test leads are not conductively coupled to the telecommunication wire, thus preventing the remaining test leads from causing a bridge tap on the telecommunication wire.

### BRIEF DESCRIPTION OF THE DRAWINGS

FIG. 1 illustrates a switched multi-lead test adapter, according to some embodiments.

FIG. 2A illustrates a top view of a switch for a multi-lead test adapter, according to some embodiments.

FIG. 2B illustrates a side view of the switch of FIG. 2A according to some embodiments.

FIG. 3 illustrates an internal detail view of the switch of FIGS. 2A-B, according to some embodiments.

FIG. 4A illustrates a top view of a switch for a multi-lead test adapter, according to some embodiments.

FIG. 4B illustrates a side view of the switch of FIG. 4A, according to some embodiments.

FIG. 5 illustrates an internal detail view of the switch of FIGS. 4A-B, according to some embodiments.

FIG. 6 illustrates an internal detail view of a switch for a multi-lead test adapter, according to some embodiments.

FIG. 7 illustrates an internal detail view of a switch for a multi-lead test adapter, according to some embodiments.

Like reference numerals refer to corresponding parts throughout the drawings.

### DESCRIPTION OF EMBODIMENTS

In light of the above described problems, a multi-lead test adapter that includes a switch between the main lead and the test leads is described. The switch allows a user to select a single test lead from among the various possible test leads. Accordingly, a user can essentially disconnect the unused or non-operative test leads from the telecommunication wire, thereby reducing or eliminating the bridge taps caused by the wires in the non-operative test leads.

In the following description, embodiments of the present invention are described with reference to telecommunication wires and telecommunication equipment. However, the disclosed embodiments are not limited to telecommunication equipment, wires, cables, etc. Rather, the invention may be used in other areas as well. Also, throughout the following description, the term “telecommunication” broadly refers to components, signals, and concepts that pertain to various types of electronic communication, such as voice or telephone communication (such as analog Plain Old Telephone Service signals and components), digital data communication signals (such as computer networking, Digital Subscriber Line, or IP protocol signals or components), or any other communication signals or components. The term telecommunication also includes any electronic communication signals, protocols, and components that facilitate communication between any electronic devices, such as computers, modems, network interfaces, audio equipment, or video equipment.

Embodiments are now described with reference to the Figures.

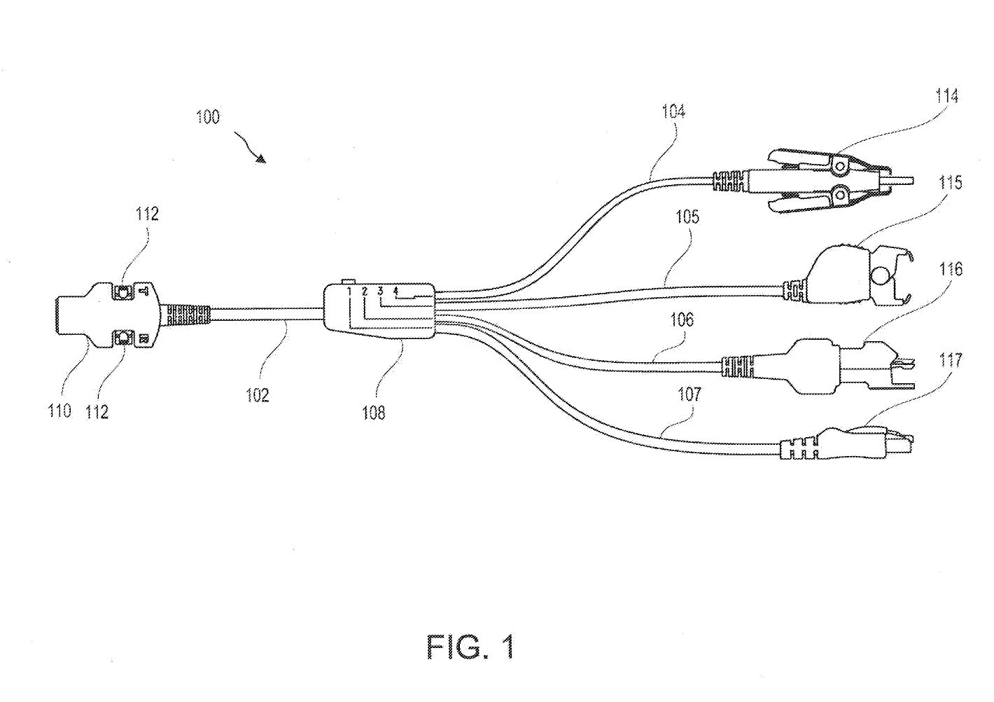

FIG. 1 illustrates a multi-lead test adapter in accordance with some embodiments. The multi-lead test adapter 100 (adapter 100) includes a main lead 102, a plurality of test leads 104-107, and a switch 108.

In some embodiments, the main lead 102 is for connection to a telecommunication testing device. In some embodiments, the main lead 102 includes two electrically isolated electrical conductors, each connected to the switch 108 at one end, and to a main terminating connector 110 at another end. In some embodiments, the main lead 102 includes two electrically isolated 24 AWG stranded conductors. In some embodiments, the main lead 102 includes three or more electrically isolated electrical conductors. In some embodiments, each electrically isolated electrical conductor in the main lead 102 corresponds to a single termination point at the main terminating connector 110, as well as to a single termination point in any of the terminating connectors of the test leads. Furthermore, each electrically isolated conductor in the main lead 102 can correspond to a particular conductor of a telephone or communication cable. In some embodiments, a telephone or communication cable is a twisted pair cable with two wires, and each conductor in the main lead 102 corresponds to one of the two wires.

In some embodiments, the main lead 102 (as well as the terminating connectors and the test leads) include additional conductors corresponding to additional available terminating points on the terminating connectors. For example, some terminating connectors may have termination points for as many as eight or more conductors. Accordingly, some embodiments of the adapter 100 include eight conductors.

As referred to herein, a cable includes single and multiple conductor configurations. For example, a 24 AWG stranded conductor (made up of multiple individual conductive wires), or a 24 AWG solid conductor (made up of a single conductive wire), may be considered cables. Likewise, multiple conductors may be paired or bundled to form a single cable. For example, two or more 24 AWG stranded conductors may be combined to form a cable. Throughout the present discussion, a cable should be understood to refer to either single or multiple conductor configurations, unless the specification indicates otherwise. Furthermore, throughout the present discussion, various lengths, gauges, and styles of electrical conductors can be implemented in embodiments of the present invention. For example, in some embodiments, the main lead includes two 26 AWG stranded conductors. In some embodiments, the main lead includes two 22 AGW stranded conductors.

The main lead 102 includes, at a remote end, a main terminating connector 110 for conductively coupling the main lead 102 to a telecommunication testing device, such as a telephone line tester, a buttset, or a digital testing device for testing DSL, T1, ISDN, or xDSL twisted pair and/or pair bonded cables. In some embodiments, the main terminating connector 110 is configured to mate directly to a telecommunication testing device. In some embodiments, the main terminating connector 110 is configured to mate to an intermediate cable, which in turn connects to a telecommunication testing device.

In some embodiments, the adapter 100 is used in other implementations without direct connection to a testing device. For example, the adapter 100 may be used as an adapter to connect telecommunication wires or other telecommunication equipment between non-compatible terminating components. Specifically, it may be necessary or desirable to bridge a gap between two separate telecommunication wires, where one cable uses a first type of connector (e.g., an RJ11 or RJ11/USB jack), while the second cable uses a second type of connector (e.g., a Dat@Term connector). Thus, the multi-lead test adapter 100 can be used to make electrical connections between various devices and cables without limitation to any specific type of telecommunication device. In some embodiments, the main lead 102 and one of the test leads 104-107 are conductively coupled in order to allow two cables to be bridged. In some embodiments, two or more of the test leads 104-107 are conductively coupled in order to bridge a cable between the connectors on the two test leads, as described in greater detail herein.

In some embodiments, the main terminating connector 110 conforms to a standard telecommunication terminating configuration, such as a “registered jack” (RJ) standard. For example, the main terminating connector 110 is in some embodiments an RJ11 receptacle (sometimes referred to as a jack). In some embodiments, the main terminating connector 110 is an RJ45 or RJ22 jack, or a jack of any other RJ configuration. In some embodiments, the main terminating connector 110 is an RJ11 plug. In some embodiments, the main terminating connector 110 is any type of plug, receptacle, or other connection mechanism that is used to conductively couple two electrical components. In some embodiments, the terminating connector 110 is a 471a quick disconnect, or any other modular-type terminating connector. Furthermore, the main terminating connector 110 is sometimes configured to mechanically retain the multi-lead adapter 100 to a test device or a cable terminating connector. For example, the main terminating connector 110 sometimes includes a clipping feature in accordance with a Registered Jack standard plug or receptacle arrangement.

In some embodiments, the main terminating connector 110 includes one or more exposed terminal posts 112. Exposed terminal posts 112 can be used for connecting the adapter 100 to telecommunication devices or cables where modular connectors are not available, broken, or otherwise inconvenient. For example, some testing equipment uses alligator-style clip connectors attached to the ends of test leads rather than modular connectors (e.g., RJ connectors). Accordingly, alligator clips can connect directly to the exposed terminal posts 112 in order to conductively couple the testing equipment (or other cables or devices) to a telecommunication wire.

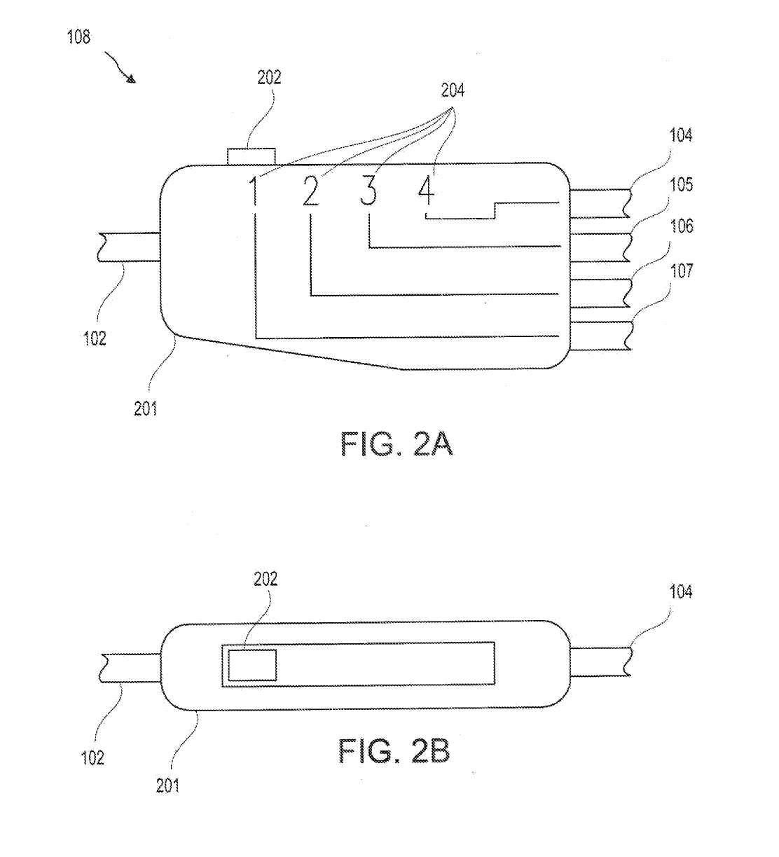

The main lead 102 is conductively coupled to a switch 108. The switch 108 is configured to conductively connect the main lead (and by extension the main terminating connector 110) to one of the plurality of test leads 104-107. The switch 108, and other switches for use with the adapter 100, are discussed in greater detail below with reference to FIGS. 2-7.

The adapter 100 also includes a plurality of test leads 104-107. The test leads are conductively coupled to the switch 108, which is configured to conductively couple a selected test lead to the main lead 102, or to another one of the test leads 104-107, as discussed in greater detail below. Each of the test leads 104-107 include, at a remote end, a terminating connector for conductively coupling the respective test lead to a telecommunication wire, wires, modular connector, or to a telecommunication device. In some embodiments, each of the test leads 104-107 have a different type of terminating connector for connecting to a different type of modular connector, for connecting to a terminal block, or for connecting directly to a telecommunication wire or other termination point. In some embodiments, the terminating connectors of the test leads 104-107 include a self strip probe 114, a binding post connector 115, a Dat@Term connector 116, and an RJ plug 117 (e.g., an RJ11, RJ45, RJ22 plug, or any modular telephone plug). In some embodiments, other types of terminating connectors are used in addition to or instead of those listed above. For example, the test leads 104-107 may include a 110 plug, 66 block, 526A, 463A, Krone, Porta, and/or BIX connector. In some embodiments, all of the terminating connectors are distinct from one another, while in other embodiments, some test leads include the same or similar terminating connectors.

In some embodiments, the plurality of test leads is made up of two, three, four, or more test leads. As shown in the figures, the adapter 100 includes four test leads, each with a distinct terminating connector. However, one of skill in the art will recognize that more or fewer test leads, and different combinations of terminating connectors, may be used without departing from the spirit of the invention.

In some embodiments, each of the test leads 104-107 include two or more electrically isolated 24 AWG stranded conductors. In some embodiments, one or more of the test leads 104-107 include (or use) only a single conductor. For example, a binding post connector typically only connects to a single telecommunication wire through a single binding post. Thus, the test lead 105 requires only a single conductor to couple the binding post connector 115 to the main lead. Where only a single conductor is required, the single conductor test lead is conductively coupled or decoupled, through the switch 108, to one of the two or more conductors of the main lead 102.

FIGS. 2-7 illustrate various switches for use with the adapter 100, according to various embodiments. The switches are designed to be connected between the main lead 102 and the test leads 104-107 of the adapter 100. When a particular test lead 104-107 is selected as the operative test lead (either manually by a user, or automatically by a sensing mechanism), the switch will conductively couple the operative test lead to the main lead 102, and decouple the remaining test leads from the main lead 102. Thus, the remaining, non-operative test leads are excluded from the conductive path of the telecommunication wire such that they do not interfere with signals present on the telecommunication line, e.g., by becoming a bridge tap.

The switches and switch components as shown and described with reference to FIGS. 2-7 are intended as functional descriptions of the switches that are used in embodiments of the adapter 100, and are not intended to be actual circuit diagrams or specific mechanical arrangements of the switches. Furthermore, as noted above, the main lead 102 and the test leads 104-107 sometimes include two or more electrically isolated electrical conductors. In the following descriptions, however, the switches are shown and described as having only single electrical paths. Thus, one of skill in the art will recognize that the functions and features of the switches can be implemented in various ways to accommodate the various conductor configurations possible between the main lead 102 and the test leads 104-107.

For example, in some embodiments, the main lead 102 and the test leads 104-107 (or a subset thereof) each include a first conductor corresponding to a T1 (or equivalent) telephone wire, and a second conductor corresponding to an R1 (or equivalent) telephone wire. In some embodiments, the switch of the adapter 100 connects or disconnects only one of the T1 or R1 signal paths between a given test lead and the main lead. In other words, the R1 signal paths of the test leads 104-107 may be permanently conductively connected (e.g., without an intervening switch) to the R1 signal path of the main lead 102. Each of the T1 signal paths of the test leads 104-107 therefore may include an intervening switch for connecting and disconnecting the T1 signal wire of the test leads 104-107 to the main lead 102. Thus, in this example, it is only necessary to include one switch mechanism for each test lead 104-107. In some embodiments, both the T1 and R1 (or equivalent) signal paths include intervening switch mechanisms to conductively couple and decouple the test leads 104-107 to the main lead 102.

In some embodiments, the switches described herein are configured to selectively couple two or more of the test leads 104-107 to one another. For example, if one test lead has an RJ11 plug, and another test lead has a self strip probe, it may be desirable to conductively couple these two test leads so that a technician can bridge a gap between telecommunication wires that each require one of these connectors. Accordingly, in some embodiments, the switches are configured to conductively couple at least two of the test leads 104-107 to each other, while also leaving the main lead 102 out of the conductive path.

Returning to FIG. 2A, the switch 108 includes a housing 201 and a selector 202. The housing 201 at least partially encloses the mechanical and electrical components of the switch 108. In some embodiments, the housing 201 is made plastic, metal, or a combination of those or any other materials.

The switch 108 also includes a selector 202. In some embodiments, the selector 202 is a linear switch that can be manually moved between various positions by a user. The selector 202 can be configured with a plurality of detents, or resting positions, corresponding to a selection of a particular test lead. Such resting positions can provide the user with feedback indicating that the switch is in a desired position, and that a desired test lead is selected. In some embodiments, the selector 202 protrudes outside of the housing 201 so that a user can more easily access the selector 202 with a finger or other instrument. In some embodiments, the selector 202 is recessed in the housing 201 so that the selector 202 is not inadvertently moved or switched due to normal jostling or manipulating during use.

In some embodiments, the switch 108 includes visual indicators 204. The visual indicators 204 provide a visual guide to a user that indicates which test lead 104-107 corresponds to which selector position. In some embodiments, the visual indicators 204 use a line to illustrate a path between a selector position (for example selector position 1) and a test lead (for example, the test lead 107). In some embodiments, the line is painted on the housing 201. In some embodiments, the line or other indicator is integrally formed or molded with the housing 201. In some embodiments, other types of visual indicators are used to indicate which test lead corresponds to a respective selector position, such as arrows, recessed channels, and/or raised edges. FIG. 2B illustrates a side view of the selector and housing of the switch in FIG. 2A.

Some embodiments of the switches described herein include active visual indicators to indicate which test lead is operative on the adapter 100. For instance, in some embodiments, a switch includes a lamp associated with each test lead. The lamps are configured to illuminate when its associated test lead is selected for use, and/or connected to a telecommunication wire. In some embodiments, the lamp is an LED or OLED light source.

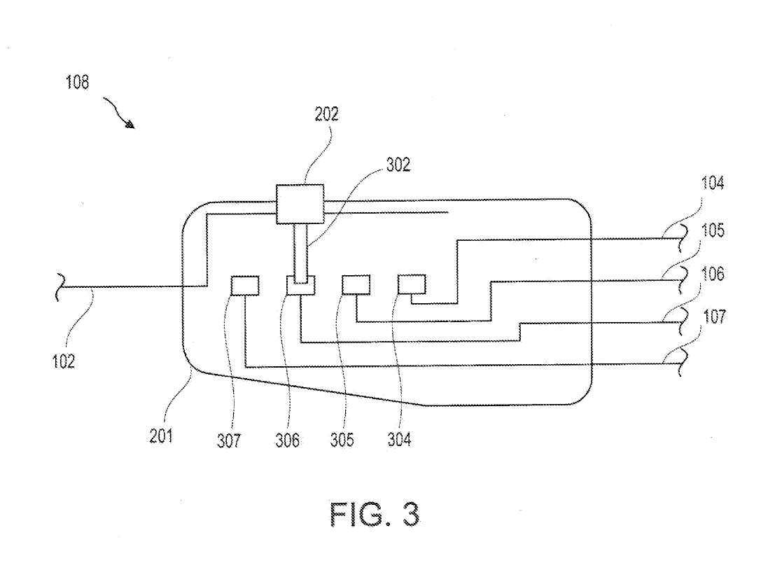

FIG. 3 is an internal depiction of the switch 108, according to some embodiments. The switch 108 includes the housing 201, the selector 202, and a switching mechanism that includes a main contact 302, and test contacts 304-307. The main contact 302 is mechanically coupled to the selector 202. The main contact 302 is also conductively coupled to the main lead 102, and is configured to conductively couple the main lead 102 to one of the test leads 104-107 through the test connectors 304-307. As the selector 202 is moved between positions, the main contact 302 is likewise moved between electrical contact points of the various test connectors 304-307. For example, when the selector 202 is in a first position corresponding to the test lead 104 being selected, the main contact 302 is conductively coupled to the test connector 306, thus conductively coupling the test lead 106 to the main lead 102. As noted, other switch configurations may be implemented in embodiments of the adapter 100 without departing from the spirit of the invention.

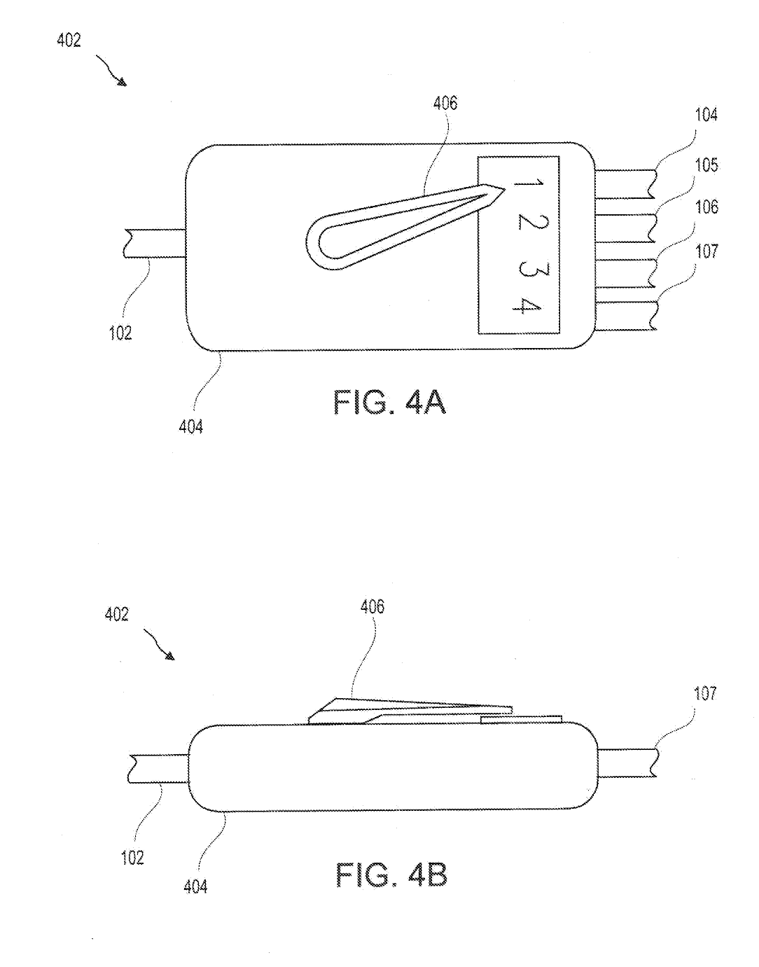

FIG. 4A illustrates a switch 402 that is used in some embodiments of adapter 100. The switch 402 includes a housing 404 and a selector 406. The housing 404 at least partially encloses the mechanical and electrical components of the switch 402. In some embodiments, the housing 404 is made plastic, metal, or a combination of those or any other materials.

The switch 402 also includes a selector 406. In some embodiments, the selector 406 is a pivoting lever or dial that can be manually moved between various positions by a user. The selector 406 can be configured with a plurality of detents, or resting positions, corresponding to a selection of a particular test lead to provide the user with feedback indicating that the switch is in a desired position. In some embodiments, the selector 406 is a pointer shaped member that is connected to the housing 404 (and to internal switch components) via a pivot at one end of the selector 406 (the pivot end). In some embodiments, the second end of the non-pivoting end of the selector 406 faces the direction of the test leads 104-107. In some embodiments, the non-pivoting end (the indicating end) points to the particular test lead 104-107 that is conductively coupled to the main lead 102. In other words, the indicating end of the selector 406 points to the test lead that is individually selected by the switch 402. In some embodiments, the pointing end of the selector 406 can point to a visual indicator other than the selected test lead, such as a number corresponding to the selected test lead. In some embodiments, the switch 402 has names of the terminating connectors of each test lead written on the housing 404. Thus, the selector 406 points to the name of the type of terminating connector of the selected test lead. In some embodiments, the housing (or some part of the switch mechanism) has detents that cause the resting positions of the selector 406 to correspond to the physical location on the housing 404 where the test leads 104-407 physically connect to the housing 404. FIG. 4B illustrates a side view of selector and housing of switch in FIG. 4A.

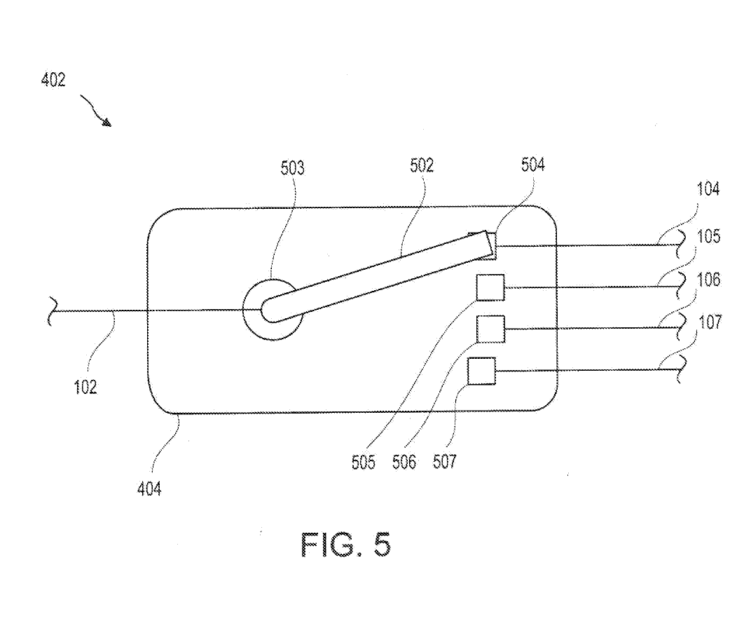

FIG. 5 illustrates an internal depiction of the switch 402, according to some embodiments. The switch 402 includes the housing 404 and a switching mechanism that includes a main contact 502, and test contacts 504-507. The main contact 502 is mechanically coupled to the selector 406 at the pivot 503. The main contact 502 is also conductively coupled to the main lead 102, and is configured to conductively couple the main lead 102 to one of the test leads 104-107 through the test connectors 504-507. As the selector 406 is moved between positions, the main contact 402 is likewise moved between electrical contact points of the various test connectors 504-507. For example, when the selector 406 is in a first position corresponding to the test lead 104 being selected, the main contact 502 is conductively coupled to the test connector 504, thus conductively coupling the main lead 102 and the test lead 104 to one another. As noted, other switch configurations may be implemented in embodiments of the adapter 100 without departing from the spirit of the invention.

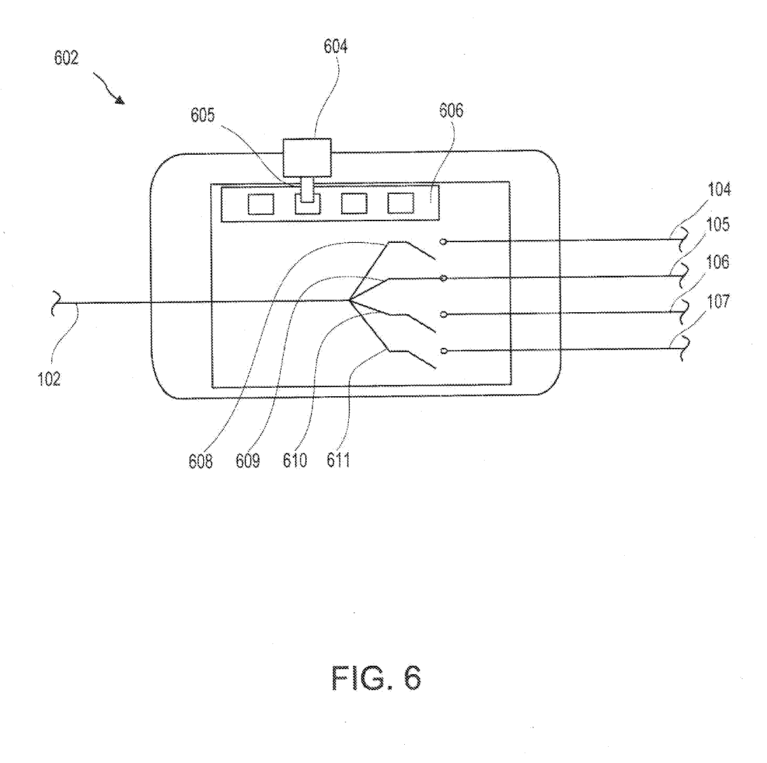

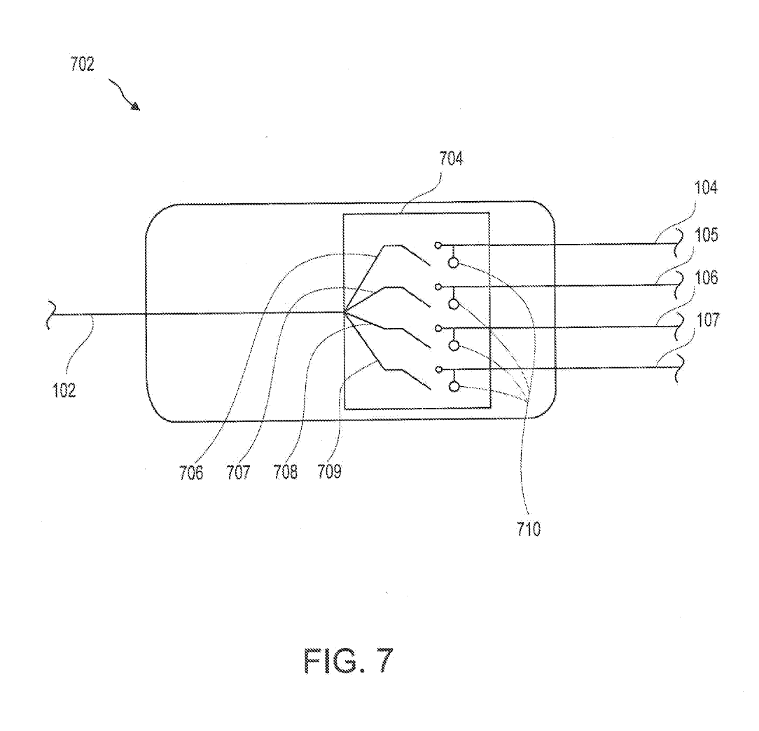

In some embodiments, the adapter 100 has a switch with electronically controlled switching components. In some embodiments, as described with reference to FIG. 6, the switch includes a manual selector allowing a user to manually select which test lead is to be connected to the main lead 102, while the conductive path between a selected test lead and the main lead 102 is completed by one or more electronic components. In some embodiments, as described with reference to FIG. 7, the switch automatically detects an operative test lead by sensing which of the test leads 104-107 is connected to a telecommunication signal wire, then individually connects that test lead to the main lead 102 and disconnects any existing connection(s).

FIG. 6 is an internal depiction of an electronically controlled switch 602 for use in the adapter 100. The switch includes a selector 604, a selector position sensor 606, and solid state switching mechanisms 608-611. In some embodiments, the selector 604 is a manual selector similar to the selector 202 described above with reference to FIG. 2. The selector position sensor 606 is an electronic component that senses the position of the selector 604. In some embodiments, the sensor 606 senses the position of the selector by sensing the presence of a slider 605 attached to the selector 604. In some embodiments, the slider 605 includes a metallic or conductive component. In some embodiments, the sensor 606 detects the position of the selector 604 when the slider 605 contacts one of a set of electrical contacts within the sensor 606.

The switch 602 also includes solid state switching mechanisms 608-611 for completing the conductive path between one of the test leads 104-107 and the main lead 102. The solid state switching mechanisms 608-611 are operated by switch control circuitry that opens and/or closes the solid state switching mechanisms based on the particular test lead that a user has selected. In some embodiments, a respective one of the solid state switching mechanisms 608-611 will be closed in response to the selector 604 being positioned at a certain position. For example, when the selector 604 is in a second position corresponding to the test lead 105 being selected, the solid state switching mechanism 609 is forced closed by the switch control circuitry, thus conductively coupling the main lead 102 and the test lead 105 to one another. In some embodiments, the solid state switching mechanisms that correspond to un-selected test leads remain in the open position, thus removing the un-selected test leads from the circuit, thereby preventing the non-operative test leads from becoming bridge taps on the telecommunication wire.

In some embodiments, the solid state switching mechanisms 608-611 include one or more transistors. In some embodiments, the solid state switching mechanisms 608-611 include one or more bipolar junction transistors (BJTs). In some embodiments, the solid state switching mechanisms 608-611 include one or more field transistors (FETs). In some embodiments, the solid state switching mechanisms 608-611 include one or more metal-oxide-semiconductor field-effect-transistors (MOSFETs). In some embodiments, various combinations of the previously mentioned solid state devices are used in one or more of the solid state switching mechanisms 608-611. In some embodiments, a solid state switching mechanism for a single conductive path includes a single solid state switch, such as a single transistor. In some embodiments, a solid state switching mechanism for a single conductive path (between individual conductors of the test leads and the main lead) includes multiple solid state switches, such as multiple transistors. One of skill in the art will recognize that various solid state switch components and configurations can be effectively used for the adapter 100. In some embodiments, the solid state switching mechanisms 608-611 include multiple switching paths, as where two conductors of the test leads are both individually coupled to and decoupled from the main lead. In some embodiments, solid state switching mechanisms are substituted with mechanical relay devices. Mechanical relay devices can be used instead of, or in addition to transistors. One of skill in the art will recognize that various combinations of control circuit components (both analog and digital) can be used in the present invention. In particular, control circuits, switching components (e.g., relays and transistors) selectors, indicators, and controllers (e.g., microprocessors) can be combined in numerous different configurations to achieve the benefits of the adapter described herein.

FIG. 7 is an internal depiction of an automatic, electronically controlled switch 702 for use in the adapter 100. The switch 702 includes an auto-sensing switch module 704 and solid state switching mechanisms 706-709.

The auto-sensing switch module 704 includes sensing circuitry for detecting which of the test leads 104-107 is conductively connected to a telecommunication wire. In some embodiments, the auto-sensing switch module 704 measures the resistance of the test leads (via sensors 710) to determine whether, a test lead has been conductively coupled to a telecommunication wire. For example, when a test lead is connected to a telecommunication wire, the electrical resistance measured by the sensing circuitry of the adapter 100 will drop significantly due to the additional conductor length of the telecommunication wire being added to that of the test lead. Thus, by monitoring for a drop in resistance of a test lead, the sensing circuitry determines that a test lead has been selected as the operative test lead (because it has been connected to a telecommunication wire), and should thus be conductively coupled to the main lead to enable signals to transfer between the test and main lead. In some embodiments, the sensing circuitry determines that a test lead is conductively coupled to a telecommunication wire when the measured resistance at the sensing circuitry is below a predetermined threshold.

In some embodiments, the auto-sensing switch module 704 detects an operative test lead by detecting a communication signal present on a telecommunication wire. Specifically, sensing circuitry in the switch module 704 can detect whether a test lead has been connected to an active telecommunication wire by sensing whether the telecommunication wire is carrying an active digital communication signal, such as a serial data communication signal, and/or an analog signal, such as an audio signal within a frequency range of approximately 200-4000 Hz.

In some embodiments, the auto-sensing switch module 704 includes one or more digital circuits that control the switch, perform sensing functions and/or calculations, and make connections between the main lead 102 and the test leads 104-107. In some embodiments, the digital circuits in the switch module 704 are used to establish conductive paths between the main lead 102 and the test leads 104-107. In some embodiments, the digital circuits are one or more of programmable logic arrays (PLAs), field-programmable gate arrays (FPGAs), application-specific integrated circuits (ASICs), systems on a programmable chip (SICs), microcontrollers (MCUs), or microprocessors.

In some embodiments, the auto-sensing switch module 704 only allows one test lead 104-107 to be conductively coupled to the main lead 102 at any given time. Specifically, in some embodiments, when a first test lead is conductively coupled to a telecommunication wire, the auto-sensing switch module 704 automatically closes the corresponding switch mechanism in order to complete the circuit between the first test lead and the main lead 102. Furthermore, after the corresponding switch mechanism is closed, the auto-sensing switch module 704 prevents all of the remaining switch mechanisms from being closed while the first test lead is conductively coupled to the telecommunication wire.

In some embodiments, the switches described with reference to FIGS. 6-7 require a power source in order to operate the electronic components of the switches 602, 702. In some embodiments, the switches 602, 702 receive power from a power supply. In some embodiments, the power supply is a battery. In some embodiments, the battery is a rechargeable battery, while in others it is non-rechargeable. In some embodiments, the power supply is a capacitor or a super-capacitor. In some embodiments, the power supply is any electricity storing device.

In some embodiments, the main lead 102 of the adapter 100 includes additional conductors that provide power to the electronic switch components. Thus, the adapter 100 can make use of a power supply that is native to the testing device to which an adapter 100 is attached.

In some embodiments, the electronic components of the switches 602, 702 are powered by the voltage that is native to the telecommunication wire to which a test lead 104-107 is attached. For instance, in some embodiments, the electronic components of the switches 602, 702 are powered by a telephone wire having a 24 volt (direct current) potential.

In some embodiments, the switch 702 includes a display screen that provides a user with information about the adapter 100. In some embodiments, the display indicates to a user a battery level (of the adapter 100 or of an attached device), the presence, absence, or strength of a signal on a telecommunication wire to which the adapter 100 is attached, and/or which of the test leads is selected and/or conductively coupled to a telecommunication wire. In some embodiments, the display screen is a liquid crystal display device.

The foregoing description, for purpose of explanation, has been described with reference to specific embodiments. However, the illustrative discussions above are not intended to be exhaustive or to limit the disclosed invention to the precise forms disclosed. Many modifications and variations are possible in view of the above teachings. The embodiments were chosen and described in order to best explain the principles and practical applications of the invention, to thereby enable others skilled in the art to best utilize them in various embodiments with various modifications as are suited to the particular use contemplated.

Moreover, in the preceding description, numerous specific details are set forth to provide a thorough understanding of the presented ideas. However, it will be apparent to one of ordinary skill in the art that these ideas may be practiced without these particular details. In other instances, components, systems, signals, and networks that are well known to those of ordinary skill in the art are not described in detail to avoid obscuring aspects of the present invention.

What is claimed is:

1. A multi-lead test adapter, comprising:
a main lead;
a plurality of test leads; and
a switch between main lead and the plurality test leads;
wherein the multi-lead test adapter is configured to conductively couple a telecommunication testing device to at least one telecommunication wire through a first respective test lead conductively coupled to the telecommunication wire, such that the remaining test leads are not conductively coupled to the telecommunication wire.

2. The multi-lead test adapter of claim 1, wherein the switch comprises a switching mechanism to conductively connect a first respective test lead to the main lead and disconnect all remaining test leads from the main lead.

3. The multi-lead test adapter of claim 1, wherein the plurality of test leads includes at least two test leads.

4. The multi-lead test adapter of claim 3, wherein the switch selects between at least two test leads.

5. The multi-lead test adapter of claim 1, wherein the switch comprises a selector for manually selecting a test lead from the plurality of test leads.

6. The multi-lead test adapter of claim 1, wherein the switch comprises sensing circuitry for detecting when the first respective test lead is conductively coupled to the telecommunication wire.

7. The multi-lead test adapter of claim 6, wherein the switch is configured to conductively connect the first respective test lead to the main test lead responsive to the sensing circuitry detecting that the first respective test lead is conductively coupled to the telecommunication wire.

8. The multi-lead test adapter of claim 1, wherein the switch comprises a visual indicator that indicates which one of the plurality of test leads is conductively coupled to the main lead.

9. The multi-lead test adapter of claim 1, the selector comprising a pivot end and an indicating end, wherein the selector causes switching components of the switch to conductively couple a selected test lead of the plurality of test leads to the main lead.

10. The multi-lead test adapter of claim 9, wherein the indicating end of the selector points to the selected test lead when the selected single test lead is conductively coupled to the main lead.

11. The multi-lead test adapter of claim 1, wherein at least one test lead comprises a self strip probe terminating connector.

12. The multi-lead test adapter of claim 1, wherein at least one test lead comprises a binding post connector-terminating connector.

13. The multi-lead test adapter of claim 1, wherein at least one test lead comprises a terminating connector corresponding to a registered jack standard configuration.

14. The multi-lead test adapter of claim 1, wherein at least one test lead comprises an RJ11 terminating connector.

15. The multi-lead test adapter of claim 1, wherein the main lead comprises a terminating receptacle for conductively coupling the main lead to the testing device via an intermediate cable.

16. The multi-lead test adapter of claim 15, wherein the terminating receptacle is an RJ11/USB jack.

17. The multi-lead test adapter of claim 15, wherein the terminating receptacle comprises a plurality of exposed terminal posts conductively coupled to a plurality of wires in the main lead.

18. A multi-lead test adapter, comprising:
a main lead;
a plurality of test leads; and
a switch between the main lead and the plurality of test leads;
wherein the multi-lead test adapter is configured to conductively couple a telecommunication testing device to at least one telecommunication wire through a single test lead conductively coupled to the telecommunication wire, such that the remaining test leads do not cause a bridge tap on the telecommunication wire.

19. A multi-lead test adapter, comprising:
a main lead configured to conductively couple to a telecommunication testing device;
a plurality of test leads, each respective test lead including a distinct terminating connector configured to conductively couple the respective test lead to a telecommunication wire; and
a switch between the main lead and the plurality of test leads.

20. The multi-lead test adapter of claim 19, wherein the switch comprises a switching mechanism to conductively connect a first respective test lead to the main lead and disconnect all remaining test leads from the main lead.

21. The multi-lead test adapter of claim 19, wherein the plurality of test leads includes at least two test leads.

22. The multi-lead test adapter of claim 19, wherein the switch selects between at least two test leads.

23. The multi-lead test adapter of claim 19, wherein the switch comprises a selector for manually selecting a test lead from the plurality of test leads.

24. The multi-lead test adapter of claim 19, wherein the switch comprises sensing circuitry for detecting when a first respective test lead is conductively coupled to the telecommunication wire.

25. The multi-lead test adapter of claim 24, wherein the switch is configured to conductively connect the first respective test lead to the main test lead responsive to the sensing circuitry detecting that the first respective test lead is conductively coupled to the telecommunication wire.

26. The multi-lead test adapter of claim 24, wherein one or more non-operative test leads are not conductively coupled to the main lead when the first respective test lead is conductively coupled to the telecommunication wire.

27. A multi-lead test adapter, comprising:
a main lead with a main terminating receptacle configured to conductively couple the main lead to a telecommunication testing device;
a plurality of test leads, each respective test lead including a distinct terminating connector configured to conductively couple the respective test lead to a telecommunication wire; and
a switch between the main lead and the plurality of test leads.

28. The multi-lead test adapter of claim 27, wherein the switch comprises a selector for manually selecting a test lead from the plurality of test leads.

29. The multi-lead test adapter of claim 27, wherein the switch comprises sensing circuitry for detecting when a first respective test lead is conductively coupled to the telecommunication wire.

30. The multi-lead test adapter of claim 29, wherein the switch is configured to conductively connect the first respective test lead to the main test lead responsive to the sensing circuitry detecting that the first respective test lead is conductively coupled to the telecommunication wire.

31. The multi-lead test adapter of claim 29, wherein one or more non-operative test leads are not conductively coupled to the main lead when the first respective test lead is conductively coupled to the telecommunication wire.

32. The multi-lead test adapter of claim 27, wherein the switch comprises a visual indicator that indicates which one of the plurality of test leads is conductively coupled to the main lead.

33. The multi-lead test adapter of claim 28, the selector comprising a pivot end and an indicating end, wherein the selector causes switching components of the switch to conductively couple a selected test lead of the plurality of test leads to the main lead.

34. The multi-lead test adapter of claim 33, wherein the indicating end, of the selector points to the selected test lead when the selected single test lead is conductively coupled to the main lead.

35. A multi-lead test adapter, comprising:
a main lead;
a plurality of test leads, each respective test lead including a distinct terminating connector configured to conductively couple the respective test lead to a telecommunication wire; and
a switch between the main lead and the plurality of test leads configured to conductively couple a first respective test lead to the main lead and disconnect all remaining test leads from the main lead.

36. The multi-lead test adapter of claim 35, wherein the switch comprises a selector for manually selecting a test lead from the plurality of test leads.

37. The multi-lead test adapter of claim 35, wherein the switch comprises a visual indicator that indicates which one of the plurality of test leads is conductively coupled to the main lead.

38. The multi-lead test adapter of claim 36, the selector comprising a pivot end and an indicating end, wherein the selector causes switching components of the switch to conductively couple a selected test lead of the plurality of test leads to the main lead.

39. The multi-lead test adapter of claim 38, wherein the indicating end of the selector points to the selected test lead when the selected single test lead is conductively coupled to the main lead.

40. The multi-lead test adapter of claim 35, wherein the plurality of test leads includes at least two test leads.

41. The multi-lead test adapter of claim 35, wherein the switch comprises sensing circuitry for detecting when the first respective test lead is conductively coupled to the telecommunication wire.

42. The multi-lead test adapter of claim 41, wherein the switch is configured to conductively connect the first respective test lead to the main test lead responsive to the sensing circuitry detecting that the first respective test lead is conductively coupled to the telecommunication wire.

43. A multi-lead test adapter, comprising:
a main lead with a main terminating receptacle configured to conductively couple the main lead to a telecommunication testing device;
a plurality of test leads, each respective test lead including a distinct terminating connector configured to conductively couple the respective test lead to a telecommunication wire; and
a switch between the main lead and the plurality of test leads configured to conductively couple a first respective test lead to the main lead and decouple all remaining test leads from the main lead.

44. A multi-lead test adapter, comprising:
a main lead with a main terminating receptacle configured to conductively couple the main lead to a telecommunication testing device;
a plurality of test leads, each respective test lead including a distinct terminating connector configured to conductively couple the respective test lead to a telecommunication wire; and
a switch between the main lead and the plurality of test leads configured to conductively couple a first respective test lead to a second conductive test lead, and decouple the main lead and all remaining test leads from the first and the second respective test leads.
